(19) United States
(12) Patent Application Publication
(10) Pub. No.: US 2006/0061488 A1
(43) Pub. Date: Mar. 23, 2006

(54) Location based task reminder

(76) Inventor: Randy R. Dunton, Phoenix, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/943,607

(22) Filed: Sep. 17, 2004

(51) Int. Cl. G08G 1/123

(52) U.S. Cl. 340/988

(57) ABSTRACT

Method and apparatus to provide a user task reminders based on location information are described.

### BACKGROUND

A person may use a digital device as an organizer to manage various tasks to be performed by the person. For example, the person may have a personal digital assistant (PDA) to create and manage a list of tasks that need to be accomplished within a certain time period. Techniques to improve management of such tasks may result in more productivity and better time management. Accordingly, there may be a need for such techniques in a device or network.

### BRIEF DESCRIPTION OF THE DRAWINGS

FIG. 1 illustrates a block diagram of a system 100.

FIG. 2 illustrates a block diagram of a node 200.

FIG. 3 illustrates a block diagram of a programming logic 300.

### DETAILED DESCRIPTION

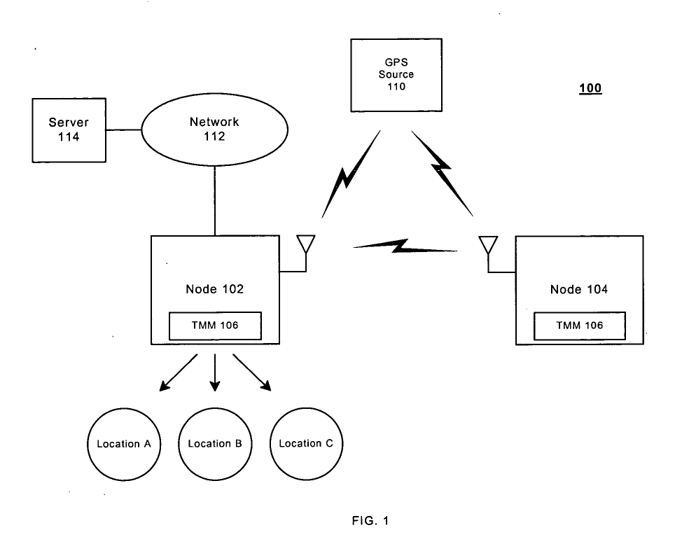

FIG. 1 illustrates a block diagram of a system 100. System 100 may comprise, for example, a communication system having multiple nodes. A node may comprise any physical or logical entity having a unique address in system 100. Examples of a node may include, but are not necessarily limited to, a computer, server, workstation, laptop, ultra-laptop, handheld computer, telephone, cellular telephone, personal digital assistant (PDA), router, switch, bridge, hub, gateway, wireless access point (WAP), and so forth. The unique address may comprise, for example, a network address such as an Internet Protocol (IP) address, a device address such as a Media Access Control (MAC) address, and so forth. The embodiments are not limited in this context.

The nodes of system 100 may be connected by one or more types of communications media and input/output (I/O) adapters. The communications media may comprise any media capable of carrying information signals. Examples of communications media may include metal leads, printed circuit boards (PCB), backplanes, switching fabrics, semiconductor material, twisted-pair wire, co-axial cable, fiber optics, radio frequency (RF) spectrum, and so forth. An information signal may refer to a signal which has been coded with information. The I/O adapters may be arranged to operate with any suitable technique for controlling information signals between nodes using a desired set of communications protocols, services or operating procedures. The I/O adapters may also include the appropriate physical connectors to connect the I/O adapters with a corresponding communications media. Examples of an I/O adapter may include a network interface, a network interface card (NIC), radio/air interface, disc controllers, video controllers, audio controllers, and so forth. The embodiments are not limited in this context.

The nodes of system 100 may be configured to communicate different types of information, such as media information and control information. Media information may refer to any data representing content meant for a user, such as voice information, video information, audio information, text information, alphanumeric symbols, graphics, images, and so forth. Control information may refer to any data representing commands, instructions or control words meant for an automated system. For example, control information may be used to route media information through a system, or instruct a node to process the media information in a predetermined manner.

The nodes of system 100 may communicate media and control information in accordance with one or more protocols. A protocol may comprise a set of predefined rules or instructions to control how the nodes communicate information between each other. The protocol may be defined by one or more protocol standards as promulgated by a standards organization, such as the Internet Engineering Task Force (IETF), International Telecommunications Union (ITU), the Institute of Electrical and Electronics Engineers (IEEE), and so forth.

Referring again to FIG. 1, system 100 may comprise nodes 102, 104, and 110. In one embodiment, for example, the nodes may comprise wireless nodes arranged to communicate information over a wireless communication medium, such as RF spectrum. To accomplish this, the nodes may include additional components and interfaces suitable for communicating information signals over the designated RF spectrum, such as omni-directional antennas, wireless RF transceivers, amplifiers, filters, control logic, and so forth. Although FIG. 1 is shown with a limited number of nodes in a certain topology, it may be appreciated that system 100 may include more or less nodes in any type of topology as desired for a given implementation. The embodiments are not limited in this context.

In one embodiment, node 110 may comprise a global positioning system (GPS) source 110. GPS source 110 may operate to provide GPS signals, and may be implemented as one or more GPS satellites. The GPS satellites may be arranged to provide GPS signals to a corresponding GPS module implemented with node 102. The GPS module may use the GPS signals to determine a location for a device (“device location”), such as nodes 102 and/or 104.

In one embodiment, system 100 may comprise nodes 102 and 104. Nodes 102 and 104 may comprise, for example, a mobile device having a processing system. The processing system may include a processor, memory, operating system (OS), and application software and/or hardware. Examples of an OS may include an operating system (OS) made by PalmSource, Inc. such as a Palm OS, an OS made by Microsoft Corporation such as Microsoft® Windows® CE, and so forth. Examples of nodes 102 and 104 may include a mobile or cellular telephone, a computer equipped with a wireless access card or modem, a handheld client device such as a wireless PDA, and so forth. In one embodiment, for example, nodes 102 and/or 104 may comprise wireless devices developed in accordance with the Personal Internet Client Architecture (PCA) by Intel® Corporation. The embodiments are not limited in this context.

Nodes 102 and 104 may also include application software. More particularly, nodes 102 and 104 may include scheduling application software. Scheduling application software may assist a user in performing various scheduling and time management operations, such as creating task items for a task list, organizing information, maintaining contact lists, coordinating projects, taking notes, and so forth. An example of scheduling software may include Microsoft Outlook® made by Microsoft Corporation. The types and number of application software may vary according a given implementation, and the embodiments are not limited in this context.

In one embodiment, node 102 may include a task management module (TMM) 106. TMM 106 may be application software and/or hardware to assist in managing a task list for a user. The task list may comprise multiple task items, with each task item representing an event, action or task to be accomplished by the user of nodes 102 or 104. In one embodiment, TMM 106 may be integrated with the scheduling application software. Alternatively, TMM 106 may be implemented separately from the scheduling application software, and may include one or more application program interfaces (API) to integrate operations of TMM 106 with the scheduling application software. The embodiments are not limited in this context.

TMM 106 may be arranged to perform various task management operations for nodes 102 and 104. Managing a task list may cause various problems, such as providing timely task reminders to a user to perform a given task. Typically, task reminders are given in response to a due date that is defined by the user. The user inputs a date and time into the scheduling application program, and when the date and time have been reached, a task reminder is displayed on a screen. This technique may have several limitations. For example, a user may not desire to enter a time and date. In another example, the user may enter a time and date, and yet not be near a resource needed to accomplish the task. In yet another example, the user may not be given proper notification of the task reminder.

TMM 106 attempts to solve these and other problems. In one embodiment, for example, TMM 106 may be arranged to create a task item and associate a task location with the task item. The task location may comprise location information for a place, device or resource that may be used to accomplish the task. Location information may include any type of information that may be used to uniquely a location. Examples of location information may include longitude and latitude coordinates for a map, an address, telephone number, GPS coordinates, and so forth. Location information for a given location may be manually entered by a user, retrieved from an internal database stored in the memory of a node, or retrieved from an external database stored by a device external to a node. In the latter case, for example, location information may be automatically retrieved by node 102 via an external database made available by server 114 via network 112. Server 114 may comprise, for example, a web server. Network 112 may comprise, for example, a packet network such as the Internet. The embodiments are not limited in this context.

By associating a task location with a task item, nodes 102 and 104 may provide a user a timely task reminder to indicate that the task may now be performed due to the proximity of the task location. TMM 106 may receive the device location from the GPS module and compare the device location with the task location. TMM 106 may then generate a task reminder for the task item if the device location is within a predetermined proximity range of the task location.

The proximity range may comprise any distance between two objects, such as nodes 102 and 104, node 102 and locations A-C, and so forth. The proximity range may be set to any desirable distance, such as 10 feet, 100 yards, 1 mile, and so forth. The proximity range may be selected by the user or may comprise a default value. In the latter case, TMM 106 may automatically select a default value for the proximity range for a given task item based on the type of task location. For example, if the task location is a place of business, the proximity range may be automatically set to 1.0 mile to account for traffic patterns and any obstacles (e.g., turning lanes, dividers, traffic signals) between the user and business. If the task location is a residence, the proximity range may be automatically set to 0.25 miles since there are typically less traffic and obstacles between the user and residence. The embodiments are not limited in this context.

In one embodiment, the task location may represent a place, such as a building, store, house, gas station, grocery store, and so forth. For example, assume a user of node 102 uses TMM 106 to create a task item having the description “buy groceries.” The user may enter one or more locations to buy groceries, such as a local grocery store, and associate the task location with the task item to “buy groceries.” Whenever node 102 comes within a predefined proximity range of the grocery store as indicated by an internal GPS module, TMM 106 may generate a task reminder to notify the user that it might be desirable to complete the task item “buy groceries” due to the proximity of the designated grocery store.

In one embodiment, the task location may represent a device, such as nodes 102 and 104. For example, assume a user A of node 102 wants to provide information or a message to a user B of node 104. User A may use TMM 106 to create a task item having the description “give user B telephone number.” Whenever node 102 approaches node 104, nodes 102 and 104 may exchange GPS information to determine whether they are within a predefined proximity range. If nodes 102 and 104 are within the predefined proximity range, TMM 106 may generate a task reminder to remind user A to provide the telephone number to user B. The embodiments are not limited in this context.

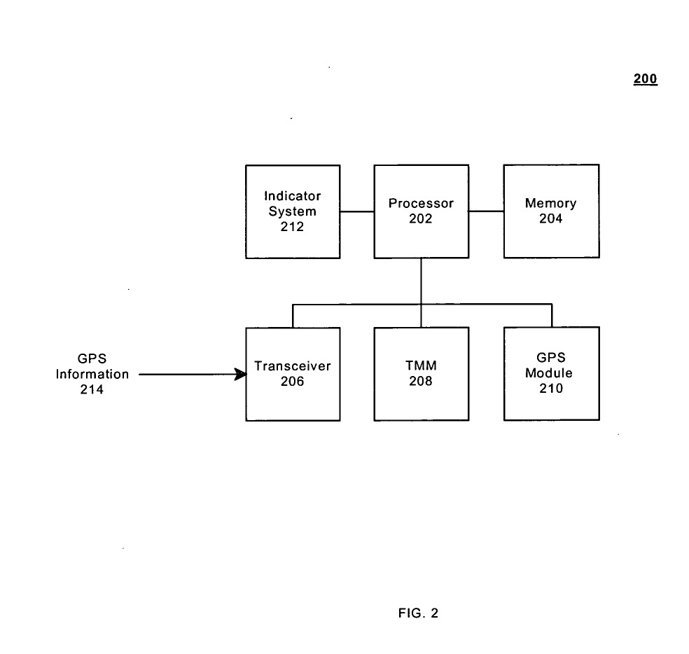

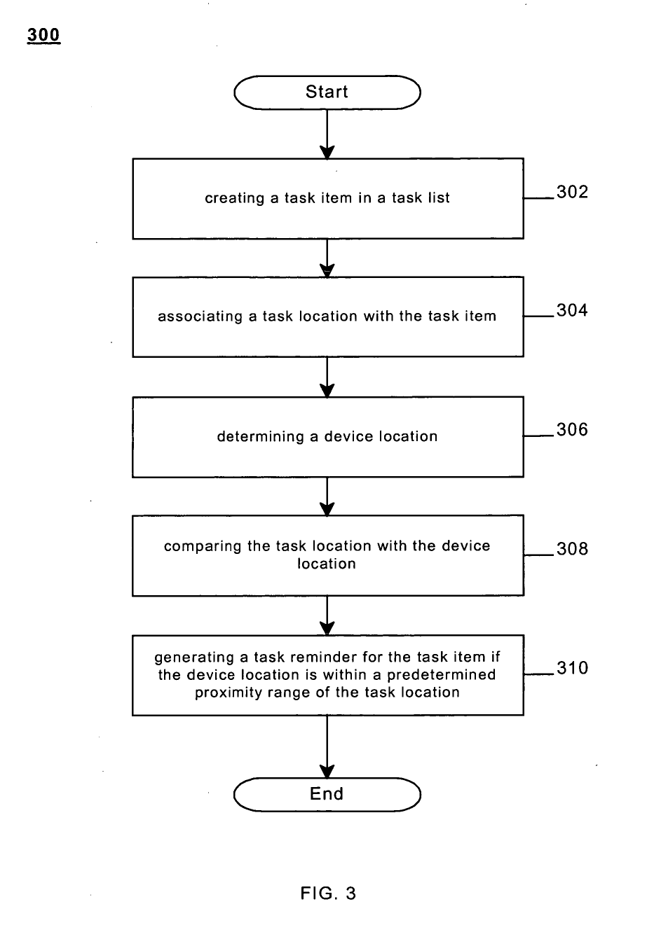

In general operation, system 100 may operate to provide task reminders for a task item whenever a node, such as node 102, is within a certain proximity to a predefined task location. For example, assume that node 102 has a task list having multiple task items. Further assume each task item is associated with a location, such as locations A-C. The GPS system of node 102 may provide location information to indicate when node 102 is within proximity of locations A-C. As node 102 approaches locations A-C, TMM 106 may provide event reminders for task items associated with locations A-C. The event reminders may be provided to a user in the form of audible indicators, visual indicators, or a combination of both. The operation of system 100 in general, and node 102 in particular, may be discussed in more detail with reference to FIGS. 2-3.

FIG. 2 illustrates a partial block diagram for a node 200. Node 200 may be representative of, for example, nodes 102 and/or 104. As shown in FIG. 2, node 200 may comprise multiple elements, such as a processor 202, a memory 204, a transceiver 206, a TMM 208, a GPS module 210, and an indicator system 212. Some elements may be implemented using, for example, one or more circuits, components, registers, processors, software subroutines, or any combination thereof. Although FIG. 2 shows a limited number of elements, it can be appreciated that more or less elements may be used in node 102 as desired for a given implementation. The embodiments are not limited in this context.

In one embodiment, node 200 may include processor 202. Processor 202 can be any type of processor capable of providing the speed and functionality desired for a given implementation. For example, processor 202 could be a processor made by Intel® Corporation and others. Processor 202 may also comprise a digital signal processor (DSP) and accompanying architecture. Processor 202 may further comprise a dedicated processor such as a network processor, embedded processor, micro-controller, controller and so forth.

In one embodiment, node 200 may include memory 204. Memory 204 may comprise electronic or magnetic memory, such as flash memory, read-only memory (ROM), random-access memory (RAM), programmable ROM, erasable programmable ROM, electronically erasable programmable ROM, dynamic RAM, synchronous RAM (SRAM), dynamic SRAM, magnetic disk (e.g., floppy disk and hard drive), optical disk (e.g., CD-ROM or DVD), and so forth. The embodiments are not limited in this context.

In one embodiment, memory 204 may comprise removable flash memory. In this manner, location information such as GPS maps may be stored on a flash memory device. The flash memory device may then be added to node 200 to provide location information for a task location, device location, and so forth. The embodiments are not limited in this context.

In one embodiment, node 200 may include transceiver 206. Transceiver 206 may comprise a wireless transceiver arranged to communicate information in accordance with a wireless communications protocol over a wireless communications medium. For example, transceiver 206 may be arranged to communicate using a wireless communications protocol as defined by the IS-95 Mobile Radio Standard. The IS-95 Mobile Radio Standard is a protocol using code division multiple access (CDMA) and quadrature phase shift-keying (QPSK)/bipolar phase shift-keying (BPSK) modulation on a carrier frequency of 824-994 megahertz (MHz) or 1.8-2.0 gigahertz (GHz). Other wireless communications protocols may include, for example, the IEEE 802.12 and 802.16 family of protocols, the Bluetooth protocol, one or more cellular telephone protocols such as the wireless access protocol (WAP), IR protocols, and so forth. The embodiments are not limited in this context.

In one embodiment, node 200 may include TMM 208. TMM 208 may be representative of, for example, TMM 106 as described with reference to FIG. 1. As discussed with reference to FIG. 1, TMM 208 may be application software and/or hardware to manage a task list for a user. For example, TMM 208 may comprise a scheduling application program such as Microsoft Outlook, as modified to include operations to associate a task location with a task location. A user may create a task item in a conventional manner, such as entering a description of the task, a due date for completion of the task, a category for the task, a priority level for the task, and so forth. In addition, TMM 208 may be used to associate a task location with the task. The task location may comprise any location information that would assist a user in remembering to perform a given task. Using our previous example, assume a user of node 200 uses TMM 208 to create a task item having the description “buy groceries.” The user may enter location information for various locations to buy groceries, such as an address for one or more grocery stores. Whenever node 200 comes within proximity of a grocery store as indicated by GPS module 212, TMM 208 may generate a task reminder. A user may be notified of the task reminder via indicator system 212.

In one embodiment, node 200 may include GPS module 210. GPS module 210 may comprise any conventional GPS module capable of providing location information for a device or object, such as node 200. GPS module 210 may have a receiver separate from, or integrated with, transceiver 206. GPS module 210 may receive digital radio signals from a GPS source via transceiver 206. For example, GPS module 210 may receive GPS information 214 from GPS source 110. GPS source 110 may comprise, for example, one or more GPS satellites. The digital radio signals may contain data on the satellites location and a predetermined time to the earth-bound receivers. The satellites are equipped with atomic clocks that are precise to within a billionth of a second. Based on this information the receivers should know how long it takes for the signal to reach the receiver on earth. As each signal travels at the speed of light, the longer it takes the receiver to get the signal, the farther away the satellite may be located. By knowing how far away a satellite is, the receiver knows that it is located somewhere on the surface of an imaginary sphere centered at the satellite. By using three satellites, GPS module 210 can calculate location information for node 200 using the longitude and latitude of the receiver based on where the three spheres intersect. By using four satellites, the GPS module can also determine altitude.

In one embodiment, node 200 may include indicator system 212. Indicator system 212 may be arranged to provide notification to a user of a task reminder. Indicator system 212 may be implemented with a number of visual, audible or sensory indicators capable of conveying information to a user. Examples of visual indicators may include a display, one or more light elements such as light emitting diodes (LED), and so forth. Examples of audio indicators may include an audio player and an audio speaker. Examples of sensory indicators may include vibrating elements to cause node 102 to vibrate. These and other indicators may be used to capture the attention of a user and provide the user notification of a given task reminder. The types and numbers of indicators are not limited in this context.

For example, assume that indicator system 212 includes a visual indicator such as a display or LED. In response to a task reminder for a task item, TMM 208 may retrieve a visual indicator parameter corresponding to the task item. The visual indicator parameter may represent a form of visual indicator to use in the event of a task reminder. The visual indicator parameter may represent, for example, a text message. When TMM 208 generates a task reminder, TMM 208 may retrieve the visual indicator parameter indicating the user desires to be notified via a text message. Indicator system 212 may then display the text message on a display for node 200. In another example, assume the visual indicator parameter represents a certain color or sequence of colors for display using one or more LEDs. In this case, indicator system 212 may notify a user of the event reminder by illuminating LEDs of a certain color on a continuous basis, on a periodic basis (e.g., blinking), a sequence of colors (e.g., alternating red and green), and so forth. The embodiments are not limited in this context.

In another example, assume that indicator system 212 includes an audio indicator such as an audio speaker. In response to a task reminder for a task item, TMM 208 may retrieve an audio indicator parameter corresponding to the task item. The audio indicator parameter may represent a form of audio indicator to use in the event of a task reminder. The audio indicator parameter may represent, for example, a certain tone or sequence of tones, a text message converted to synthetic speech, a digital or analog audio file, and so forth. In this case, indicator system 212 may notify a user of the event reminder by reproducing the tone, sequence of tones, reproducing an audio file, and so forth. The embodiments are not limited in this context.

Operations for the above system and subsystem may be further described with reference to the following figures and accompanying examples. Some of the figures may include programming logic. Although such figures presented herein may include a particular programming logic, it can be appreciated that the programming logic merely provides an example of how the general functionality described herein can be implemented. Further, the given programming logic does not necessarily have to be executed in the order presented unless otherwise indicated. In addition, the given programming logic may be implemented by a hardware element, a software element executed by a processor, or any combination thereof. The embodiments are not limited in this context.

FIG. 3 illustrates a programming logic 300. Programming logic 300 may be representative of the operations executed by one or more systems described herein, such as system 100 or node 200. As shown in programming logic 300, a task item for a task list may be created at block 302. A task location may be associated with the task item at block 304. A device location may be determined at block 306. The device location may be representative of the GPS coordinates for node 200. The task location may be compared with the device location at block 308. A task reminder for the task item may be generated if the device location is within a predetermined proximity range to the task location at block 310. Blocks 306 and 308 may be repeated on a periodic basis until the task reminder is generated at block 310.

A user may be notified of a task reminder in number of different ways. For example, a visual indicator parameter corresponding to the task reminder may be retrieved. A visual indicator for a user may be displayed in accordance with the visual indicator parameter. In another example, an audio indicator parameter corresponding to the task reminder may be retrieved. An audio indicator for a user may be reproduced in accordance with the audio indicator parameter. The embodiments are not limited in this context.

A task location may be associated with a task item in a number of different ways. For example, a user may input a name for a location into node 200. Location information corresponding to the location name may be retrieved from a location table or GPS map that is part of TMM 106. In another example, node 102 may display a map of a given area, and a user may touch a location on the map to generate the appropriate GPS coordinates. The embodiments are not limited in this context.

The location table may comprise a data structure having a set of location names and their corresponding location information. The location table may be formed and updated using information retrieved from a database. The database may comprise an external database, such as a database made available by server 114 via network 112. The database may also comprise an internal database, such as a GPS map stored on a removable flash memory card implemented for memory 204. The embodiments are not limited in this context.

The device location may comprise a set of GPS coordinates derived using signals from GPS source 110. The task location and set of GPS coordinates may be used to determine whether node 200 is within a certain predetermined proximity range of a task location. As previously described, the proximity range may vary according to a given implementation, and may comprise a parameter selected by the user or set as a default with delivery of node 200. The embodiments are not limited in this context.

The operation of the above described systems and associated programming logic may be better understood by way of example. An example of a task list having multiple task items with associated task locations and indicator parameters may be illustrated in Table 1 as follows:

TABLE 1

| Task Item | Task Location | Indicator Parameter | Proximity Range |
|---|---|---|---|
| Buy Groceries | Location A | 000 - Provide | 1.0 miles |
| | | Continuous | |
| | | Beeping | |
| Drop Off Dry | Location B | 001 - Audibly | 1.5 miles |
| Cleaning | | reproduce | |
| | | Task Item using | |
| | | Text-To-Speech | |
| Deliver | Location C | 010 - Display | 0.25 miles |
| Present To | | Task Item | |
| Friend | | | |

Referring to Table 1, assume node 102 gets within a certain proximity of Location A (e.g., a grocery store) as shown in FIG. 1. Further assume a user has set a proximity range of approximately 1.0 miles. As node 102 moves, GPS module 210 periodically provides GPS coordinates of node 102 to TMM 106. When TMM 106 determines that node 102 is within 1.0 miles of Location A, TMM 106 may generate a task reminder for a user of node 102. TMM 106 may retrieve indicator parameter “000”, which may represent an audio indicator parameter. TMM 106 may send a message or signal to indicator system 212 to produce a continuous beeping using an audio speaker.

In another example, assume node 102 gets within 1.5 miles of Location B. TMM 106 may generate a task reminder for a user of node 102. TMM 106 may retrieve indicator parameter “001”, which may represent an audio indicator parameter. TMM 106 send a message or signal to indicator system 212 to reproduce the text phrase “Drop Off Dry Cleaning” in audible form using a text-to-speech converter.

In yet another example, assume node 102 gets within 0.25 miles of Location C. TMM 106 may generate a task reminder for a user of node 102. TMM 106 may retrieve indicator parameter “010”, which may represent a visual indicator parameter. TMM 106 may send a message or signal to indicator system 212 to display a text message such as “Deliver Present To Friend” on a display for node 102.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

It is also worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some embodiments may be implemented using an architecture that may vary in accordance with any number of factors, such as desired computational rate, power levels, heat tolerances, processing cycle budget, input data rates, output data rates, memory resources, data bus speeds and other performance constraints. For example, an embodiment may be implemented using software executed by a general-purpose or special-purpose processor. In another example, an embodiment may be implemented as dedicated hardware, such as a circuit, an application specific integrated circuit (ASIC), Programmable Logic Device (PLD) or digital signal processor (DSP), and so forth. In yet another example, an embodiment may be implemented by any combination of programmed general-purpose computer components and custom hardware components. The embodiments are not limited in this context.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

1. An apparatus, comprising:
a global positioning system module to determine a device location; and
a task management module to connect to said global positioning system module, said task management module to create a task item and associate a task location with said task item, said task management module to receive said device location, compare said device location with said task location, and generate a task reminder for said task item if said device location is within a predetermined proximity range of said task location.

2. The apparatus of claim 1, further comprising an indicator system to connect to said task management module, said indicator system to notify a user of said task reminder, with said indicator system to include at least one of a display, light emitting diode, vibrating element, and audio speaker.

3. The apparatus of claim 2, wherein said task management module is arranged to retrieve a visual indicator parameter corresponding to said task item, said indicator system to receive said visual indicator parameter and provide a visual indicator of said task reminder for said user corresponding to said visual indicator parameter using at least one of said display or light emitting diode.

4. The apparatus of claim 2, wherein said task management module is arranged to retrieve an audio indicator parameter corresponding to said task item, and reproduce an audio indicator for said user in accordance with said audio indicator parameter using said audio speaker.

5. The apparatus of claim 1, wherein said task management module further comprises a location table having location names with corresponding location information, said task management module to receive said task location, retrieve location information corresponding to said task location, and associate said location information with said task item.

6. A system, comprising:
an antenna;
a global positioning system module to connect to said antenna, said global positioning system module to determine a device location using said antenna; and
a task management module to connect to said global positioning system module, said task management module to create a task item and associate a task location with said task item, said task management module to receive said device location, compare said device location with said task location, and generate a task reminder for said task item if said device location is within a predetermined proximity range of said task location.

7. The system of claim 6, further comprising an indicator system to connect to said task management module, said indicator system to notify a user of said task reminder, with said indicator system to include at least one of a display, light emitting diode, vibrating element, and audio speaker.

8. The system of claim 7, wherein said task management module is arranged to retrieve a visual indicator parameter corresponding to said task item, said indicator system to receive said visual indicator parameter and provide a visual indicator of said task reminder for said user corresponding to said visual indicator parameter using at least one of said display or light emitting diode.

9. The system of claim 7, wherein said task management module is arranged to retrieve an audio indicator parameter corresponding to said task item, and reproduce an audio indicator for said user in accordance with said audio indicator parameter using said audio speaker.

10. The system of claim 6, wherein said task management module further comprises a location table having location names with corresponding location information, said task management module to receive said task location, retrieve location information corresponding to said task location, and associate said location information with said task item.

11. A method, comprising:
creating a task item in a task list;
associating a task location with said task item;
determining a device location;
comparing said task location with said device location; and
generating a task reminder for said task item if said device location is within a predetermined proximity range of said task location.

12. The method of claim 11, further comprising:
retrieving a visual indicator parameter corresponding to said task reminder; and
displaying a visual indicator for a user in accordance with said visual indicator parameter.

13. The method of claim 11, further comprising:
retrieving an audio indicator parameter corresponding to said task reminder; and
reproducing said audio indicator for a user in accordance with said audio indicator parameter.

14. The method of claim 11, wherein said associating comprises:
receiving said task location;
retrieving location information corresponding to said task location; and
associating said location information with said task item.

15. The method of claim 11, wherein determining said device location comprises determining a set of global positioning system coordinates using signals from a global positioning system.

16. An article, comprising:
a storage medium;
said storage medium including stored instructions that, when executed by a processor, are operable to create a task item in a task list, associate a task location with said task item, determine a device location, compare said task location with said device location, and generate a task reminder for said task item if said device location is within a predetermined proximity range of said task location.

17. The article of claim 16, wherein the stored instructions, when executed by a processor, are further operable to retrieve a visual indicator parameter corresponding to said task reminder, and display a visual indicator for a user in accordance with said visual indicator parameter.

18. The article of claim 16, wherein the stored instructions, when executed by a processor, are further operable to retrieve an audio indicator parameter corresponding to said task reminder, and reproduce said audio indicator for a user in accordance with said audio indicator parameter.

19. The article of claim 16, wherein the stored instructions, when executed by a processor, perform said associating using stored instructions operable to receive said task location, retrieve location information corresponding to said task location, and associate said location information with said task item.

20. The article of claim 16, wherein the stored instructions, when executed by a processor, perform said determining using stored instructions operable to determine a set of global positioning system coordinates using signals from a global positioning system.
